(19) United States
(12) Patent Application Publication
(10) Pub. No.: US 2026/0104339 A1
(43) Pub. Date: Apr. 16, 2026

(54) EXHAUST GAS DILUTION APPARATUS AND PARTICLE MEASUREMENT APPARATUS INCLUDING THE SAME

(71) Applicants: Samsung Electronics Co., Ltd., Suwon-si (KR); Uif (University Industry Foundation), Yonsei University, Seoul (KR)

(72) Inventors: Hani Kang, Suwon-si (KR); Jungho Hwang, Seoul-si (KR); Jaeho Oh, Seoul-si (KR); Jiwoo Jung, Seoul-si (KR)

(73) Assignees: Samsung Electronics Co., Ltd., Suwon-si (KR); Uif (University Industry Foundation), Yonsei University, Seoul (KR)

(21) Appl. No.: 19/323,106

(22) Filed: Sep. 9, 2025

(30) Foreign Application Priority Data
Oct. 16, 2024 (KR) 10-2024-0141616
Feb. 19, 2025 (KR) 10-2025-0021538

(51) Int. Cl. G01N 15/06; G01N 1/38

(52) U.S. Cl. CPC G01N 15/06; G01N 1/38

(57) ABSTRACT

Provided is an exhaust gas dilution apparatus including a sampler configured to have a portion arranged in a pipe through which exhaust gas flows and to provide a path through which a portion of the exhaust gas flows to outside of the pipe, a diluter connected to the sampler and configured to receive the portion of exhaust gas diverted from the pipe and dilute the portion of exhaust gas with external gas to generate diluted gas, and a housing unit surrounding the diluter and configured to prevent at least one of the exhaust gas and the diluted gas from leaking outside of the diluter.

### CROSS-REFERENCE TO RELATED APPLICATIONS

This application is based on and claims priority under 35 U.S.C. § 119 to Korean Patent Application Nos. 10-2024-0141616, filed on Oct. 16, 2024, and 10-2025-0021538, filed on Feb. 19, 2025, in the Korean Intellectual Property Office, the disclosures of which are incorporated by reference herein in their entirety.

### BACKGROUND

The inventive concept relates to an exhaust gas dilution apparatus and a particle measurement apparatus including the same. The inventive concept relates to an exhaust gas dilution apparatus capable of diluting and measuring high-concentration particles discharged from an exhaust system of a semiconductor manufacturing process, and a particle measurement apparatus including the same.

In the semiconductor manufacturing process, fine particles are emitted along with various process gases, and in order to analyze characteristics of these particles, it is necessary to measure the size and concentration of representative particles sampled from the exhaust system. Particle measurement using a particle measurement device provides important data for optimizing exhaust system maintenance cycles and process conditions. In particular, safe sampling and dilution techniques are required to measure particles emitted along with harmful gases. In many cases, the concentration of the emitted particles exceeds a measurement range of the particle measurement device, making appropriate dilution essential, and a safety system is required to protect workers and measurement equipment from harmful gases.

### SUMMARY

In some embodiments, there is provided an apparatus capable of safely diluting and measuring high-concentration particles in an exhaust system of a semiconductor manufacturing process.

In some embodiments, there is also provided an exhaust gas dilution apparatus having a multi-stage dilution structure, capable of achieving a high dilution ratio using a small amount of diluted air.

In some embodiments, there is also provided a sealed particle measurement apparatus capable of preventing emission of harmful gases included in exhaust gas into the atmosphere.

In some embodiments, there is also provided an exhaust gas dilution apparatus capable of effectively removing moisture from exhaust gas to improve accuracy of particle measurement.

The technical objects of the inventive concept are not limited to the technical objects mentioned above, and other technical objects not mentioned herein will be clearly understood by those of ordinary skill in the art from the following description.

According to some embodiments, there is provided an exhaust gas dilution apparatus including a sampler configured to have a portion arranged in a pipe through which exhaust gas flows and to provide a path through which the exhaust gas flows outside of the pipe, a diluter in connected to the sampler and configured to receive the portion of exhaust gas diverted from the pipe which the exhaust gas that has moved via the sampler is diluted by and dilute the portion of exhaust gas with external gas to generate diluted gas, and a housing unit surrounding the diluter and configured to prevent at least one of the exhaust gas and the diluted gas from leaking outside of the diluter.

According to some embodiments, there is provided an exhaust gas dilution apparatus including a sampler having a first end configured to be arranged in a pipe configured to convey an exhaust gas and to provide a path through which a portion of the exhaust gas flows to a second end of the sampler external to the pipe, a diluter configured to receive the portion of the exhaust gas from the sampler and dilute the portion of the exhaust gas with an external gas to generate diluted gas, and a housing unit surrounding the diluter and configured to prevent at least one of the exhaust gas and the diluted gas from leaking from the diluter, wherein the diluter includes a first dilution chamber configured to receive the portion of the exhaust gas from the sampler and to receive the external gas, and to dilute the exhaust gas with the external gas to generate a first diluted gas, and a second dilution chamber configured to receive the first diluted gas from the first dilution chamber and to receive the external gas, and in which the first diluted gas is further diluted by the external gas to generate a second diluted gas.

According to some embodiments, there is provided a particle measurement apparatus including a sampler having a first end configured to be arranged in a pipe through which exhaust gas moves and configured to provide a path through which a portion of the exhaust gas flows to outside of the pipe, a diluter configured to receive the portion of the exhaust gas from the sampler and dilute the portion of the exhaust gas with an external gas to generate diluted gas, a particle measurement device configured to measure particles in the diluted gas, and a housing unit surrounding the diluter and the particle measurement device and configured to prevent leakage of the exhaust gas from at least one of the diluter and the particle measurement device, wherein the diluter includes at least one dilution chamber configured to receive the portion of the exhaust gas from the sampler and the external gas, and configured to dilute the exhaust gas by the external gas to generate the diluted gas.

### BRIEF DESCRIPTION OF THE DRAWINGS

Embodiments will be more clearly understood from the following detailed description taken in conjunction with the accompanying drawings in which:

FIG. 1 is a configuration diagram schematically illustrating a particle measurement apparatus including an exhaust gas dilution apparatus, according to an embodiment;

FIG. 2 is a cross-sectional view schematically illustrating an embodiment of a dilution chamber shown in FIG. 1;

FIG. 3 is a configuration diagram schematically illustrating a particle measurement apparatus including an exhaust gas dilution apparatus, according to another embodiment;

FIG. 4 is a configuration diagram schematically illustrating a particle measurement apparatus including an exhaust gas dilution apparatus, according to another embodiment;

FIG. 5 is a configuration diagram schematically illustrating a particle measurement apparatus including an exhaust gas dilution apparatus, according to another embodiment;

FIG. 6 is a configuration diagram schematically illustrating a particle measurement apparatus including an exhaust gas dilution apparatus, according to another embodiment;

FIG. 7 is a configuration diagram schematically illustrating a particle measurement apparatus including an exhaust gas dilution apparatus, according to another embodiment; and

FIG. 8 is a configuration diagram schematically illustrating a particle measurement apparatus including an exhaust gas dilution apparatus, according to another embodiment.

### DETAILED DESCRIPTION OF THE EMBODIMENTS

Embodiments of the inventive concept will now be described more fully hereinafter with reference to the accompanying drawings. The invention may, however, be embodied in many different forms and should not be construed as limited to the example embodiments set forth herein. It should also be emphasized that the disclosure provides details of alternative examples, but such listing of alternatives is not exhaustive. Furthermore, any consistency of detail between various examples should not be interpreted as requiring such. In the description, certain detailed explanations of well-known related functions or configurations may be omitted when it is deemed that such descriptions may unnecessarily obscure the description of the inventive concept. The language of the claims should be referenced in determining the requirements of the invention.

Throughout the specification, when a component is described as “including” a particular element or group of elements, it is to be understood that the component is formed of only the element or the group of elements, or the element or group of elements may be combined with additional elements to form the component, unless the context indicates otherwise. The term “consisting of,” on the other hand, indicates that a component is formed only of the element(s) listed.

It will be understood that when an element is referred to as being “connected” or “coupled” to or “on” another element, it can be directly connected or coupled to or on the other element or intervening elements may be present. In contrast, when an element is referred to as being “directly connected” or “directly coupled” to another element, or as “contacting” or “in contact with” another element (or using any form of the word “contact”), there are no intervening elements present at the point of contact.

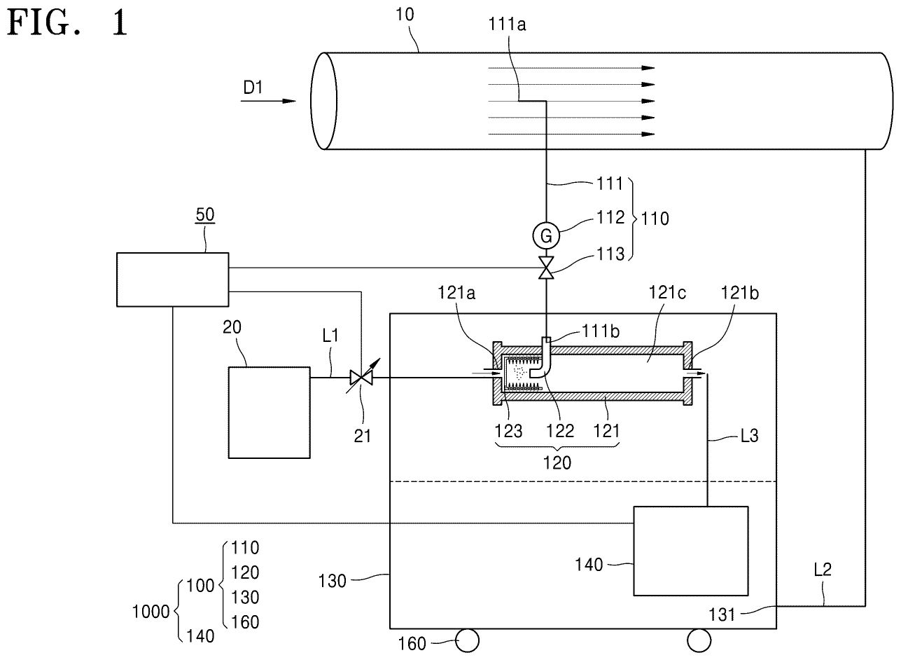

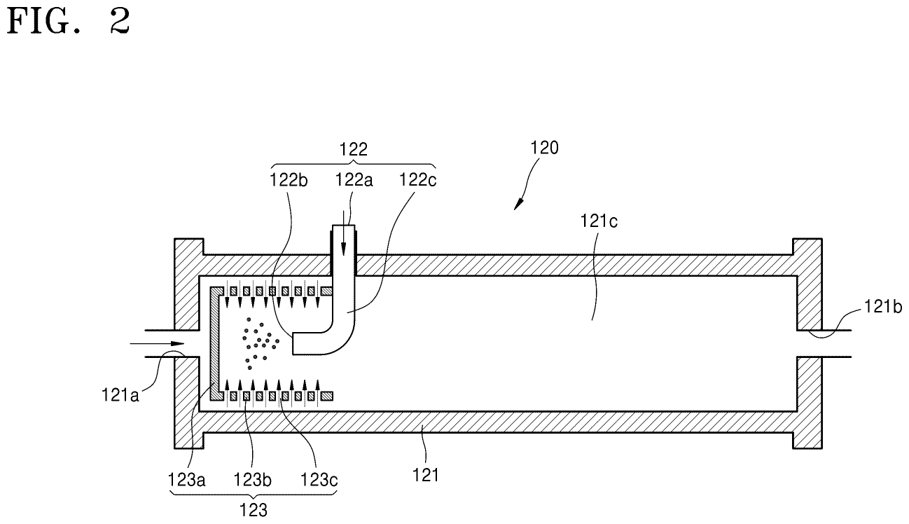

FIG. 1 is a configuration diagram schematically illustrating a particle measurement apparatus including an exhaust gas dilution apparatus, according to an embodiment, and FIG. 2 is a cross-sectional view schematically illustrating an embodiment of a dilution chamber shown in FIG. 1.

Referring to FIGS. 1 and 2, a particle measurement apparatus 1000 according to an embodiment may include an exhaust gas dilution apparatus 100 and a particle measurement device 140. A controller 50 may communicate with the components of the gas dilution apparatus 100 and the particle measurement device 140 to control the particle measurement apparatus. The exhaust gas dilution apparatus 100 may include a sampling unit 110, a diluter 120, a housing unit 130, and a mobility unit 160.

The sampler 110 may have a portion thereof arranged in a pipe 10 and sample exhaust gas from within the pipe 10. The sampler 110 may perform a function of accurately capturing exhaust gas within the pipe 10 and transferring the exhaust gas to the diluter 120.

The sampler 110 may include, for example, a sampling pipe 111, a flow meter 112, and an on/off valve 113.

The sampling pipe 111 may have a first sampling opening 111a at a first end thereof and a second sampling opening 111b at a second end thereof. The first sampling opening 111a may be located in the pipe 10, and the second sampling opening 111b may be connected to the diluter 120 in the housing unit 130.

The sampling pipe 111 may have the first sampling opening 111a formed parallel to a main flow direction D1 of the pipe 10 to enable isokinetic sampling within a flow field inside the pipe 10. An inner diameter of the sampling pipe 111 is designed to enable sampling at the same flow rate or velocity as a flow rate or velocity inside the pipe 10, thereby enabling sampling of particles within in the exhaust gas. The flow meter 112 may monitor whether isokinetic sampling conditions are maintained, by measuring, in real-time, a flow rate or velocity of the exhaust gas flowing inside the sampling pipe 111. As a modified example, the on/off valve 113 may be replaced with a control valve. The control valve may allow only exhaust gas with a specific flow rate to flow into the diluter 120, by precisely controlling the flow inside the sampling pipe 111.

The diluter 120 may dilute the exhaust gas having a high concentration of a component being measured to a lower concentration suitable for a measurement range of the particle measurement device 140. Referring to FIG. 2, the diluter 120 may include, for example, a dilution chamber 121, an aerosol inlet 122, and a path change unit 123.

The dilution chamber 121 may include, for example, a first dilution chamber opening 121a, a second dilution chamber opening 121b, and a dilution chamber internal space 121c.

The dilution chamber 121 may have, for example, a cylindrical structure.

The first dilution chamber opening 121a may be formed in a first side of the dilution chamber 121, and the second dilution chamber opening 121b may be formed in a second side of the dilution chamber 121. External gas may be introduced via the first dilution chamber opening 121a from an external gas supply source 20. The first dilution chamber opening 121a may be connected to the external gas supply source 20 via a first line L1. The external gas may be introduced from the external gas supply source 20 to the dilution chamber internal space 121c via the first dilution chamber opening 121a through the first line L1. The external gas supplied from the external gas supply source 20 may be nitrogen or clean air (e.g., air having minimal or no contaminants such as air after undergoing a filtering process).

Efficient mixing of the exhaust gas and the external gas occurs in the dilution chamber internal space 121c, and diluted gas may be generated by mixing the exhaust gas and the external gas.

The second dilution chamber opening 121b may be positioned collinear with the first dilution chamber opening 121a, thereby allowing the external gas to flow in a single direction, that is, from the first dilution chamber opening 121a toward the second dilution chamber opening 121b.

The aerosol inlet 122 may serve to effectively transfer the sampled exhaust gas into the dilution chamber 121. The aerosol inlet 122 may have, for example, a first inlet opening 122a, which is at a first end thereof, located outside the dilution chamber 121 and a second inlet opening 122b, which is at a second end thereof, located inside the dilution chamber 121.

The first inlet opening 122a may be connected to the second sampling opening 111b in the sampling pipe 111. The exhaust gas flowing via the sampling pipe 111 may flow to the first inlet opening 122a via the second sampling opening 111b.

The second inlet opening 122b may be arranged in the dilution chamber 121 to face the first dilution chamber opening 121a, thereby facilitating collision and natural mixing of the exhaust gas and the external gas.

An inlet internal path 122c may prevent particle loss by minimizing the inertial force of the exhaust gas.

The path change unit 123 may be arranged in the dilution chamber 121. The path change unit 123 has a structure capable of preventing the exhaust gas from accumulating on an inner surface of the dilution chamber 121. The path change unit 123 may include, for example, a partition wall portion 123a and a porous portion 123b.

The partition wall portion 123a may have an area smaller than an inner cross-sectional area of the dilution chamber 121, and may be arranged between the first dilution chamber opening 121a and the second inlet opening 122b. The partition wall portion 123a may be configured to prevent direct mixing of the external gas with the exhaust gas in the flow direction of the external gas passing through the first dilution chamber opening 121a. For example, the partition wall portion 123a may be arranged to block an inflow direction of the external gas, and the external gas introduced via the first dilution chamber opening 121a may have its flow direction changed by the partition wall portion 123a from a direction of inflow into the dilution chamber 121 to a direction perpendicular thereto.

The external gas may have its flow direction changed by the partition wall portion 123a and may then be directed toward an inner wall of the dilution chamber 121. The external gas may have its flow direction changed again by the inner wall of the dilution chamber 121 and may move via a porous pattern 123c of the porous portion 123b.

The porous portion 123b may, for example, extend from an edge of the partition wall portion 123a in a direction from the first dilution chamber opening 121a toward the second dilution chamber opening 121b, and may have a plurality of porous patterns 123c. The external gas whose flow direction is changed by the partition wall portion 123a may flow via the porous pattern 123c and be dispersed. The external gas dispersed by the porous portion 123b may be mixed with the exhaust gas introduced via the second inlet opening 122b.

The partition wall portion 123a controls linear flow of the external gas, and the external gas may be uniformly dispersed via the porous pattern 123c of the porous portion 123b. This structure may prevent the exhaust gas including particles from being deposited on the inner wall of the dilution chamber 121 and improve dilution efficiency.

The housing unit 130 may have a sealed structure that blocks external leakage of the exhaust gas and/or the diluted gas. The housing unit 130 may have a sealed structure surrounding the diluter 120 and the particle measurement device 140. The housing unit 130 may have arranged therein the diluter 120 and the particle measurement device 140 in a single internal space, or may be divided into two internal spaces, with the diluter 120 arranged in one space and the particle measurement device 140 arranged in a second space.

The housing unit 130 may have a first exhaust port 131. The first exhaust port 131 may be connected to a second line L2. The second line L2 may have a first end connected to the first exhaust port 131 and a second end connected to the pipe 10.

The exhaust gas, the diluted gas, or the external gas may leak out from the diluter 120, the particle measurement device 140, the sampler 110, the aerosol inlet 122, the first line L1, a third line L3, or their connection portions, inside the housing unit 130. The housing unit 130 may discharge the exhaust gas, the diluted gas, or the external gas, inside the housing unit 130, to the outside of the housing unit 130 only through the first exhaust port 131, and may prevent leakage of the exhaust gas, the diluted gas, or the external gas through any parts other than the first exhaust port 131.

The discharged exhaust gas, diluted gas, or external gas may be safely recirculated to the pipe 10 via the second line L2. This may prevent emission of harmful gases into the atmosphere and ensure system safety.

The mobility unit 160 may be installed under the housing unit 130 and provide apparatus mobility. The mobility unit 160 may include, for example, a wheel, a track, a roller, a slider, a magnetic levitation apparatus, or an air cushion movement apparatus. This may allow flexible sampling at various measurement locations and also improve convenience of maintenance.

The external gas supply source 20 may be connected to the first dilution chamber opening 121a via the first line L1. The external gas supply source 20 may supply the external gas at a precisely controlled flow rate via the first line L1 and a control valve 21. The control valve 21 may precisely control a dilution ratio, enabling measurement of particles of various concentrations.

The particle measurement apparatus 1000 according to an embodiment may include the exhaust gas dilution apparatus 100 and the particle measurement device 140.

The particle measurement device 140 may measure particles in the diluted gas. The particle measurement device 140 may be connected to the second dilution chamber opening 121b in the diluter 120 via the third line L3. The third line L3 may provide a path through which the diluted gas is transferred to the particle measurement device 140.

The particle measurement device 140 may measure the size and concentration of the particles in the diluted gas. The particle measurement device 140 may measure the size and concentration of the particles in real-time and may continuously monitor a size distribution and concentration distribution of the particles. The particle measurement device 140 may include, for example, an aerodynamic particle sizer (APS), a scanning mobility particle sizer (SMPS), an electrical low pressure impactor (ELPI), or an optical particle counter (OPC).

The particle measurement device 140 may measure the particles in the diluted gas introduced via the third line L3. The particle measurement device 140 may measure the particles in the diluted gas and then discharge the measured diluted gas. The diluted gas discharged from the particle measurement device 140 may be discharged via the first exhaust port 131 of the housing unit 130. The discharged diluted gas may be recirculated to the pipe 10 via the second line L2.

The controller 50 may be a processor (i.e., a hardware circuit), such as a microprocessor, a CPU (Central Processing Unit), a GPU (graphics processor), a digital signal processor (DSP), a field-programmable gate array (FPGA), etc., and may be part of a computer. Such a controller may be formed by several interconnected controllers and may be configured by software. The controller may include analog-to-digital converters and digital to analog converters configured to communicate with sensors and components of the exhaust gas dilution apparatus 100 to control the operation thereof.

The particle measurement device 140 may transfer information about the measured size and concentration of the particles to the controller 50. The controller 50 may control a dilution ratio in the diluter 120 by using the information about the size and concentration of the particle, the information being received from the particle measurement device 140. For example, the controller 50 may control a flow rate of the external gas supplied from the external gas supply source 20, by controlling the control valve 21 by using the information about the size and concentration of the particles. Accordingly, the concentration of the particles in the diluted gas may be maintained within the measurement range of the particle measurement device 140.

The particle measurement device 140 may include one or more particle measurement devices. For example, the particle measurement device 140 may include a plurality of particle measurement devices having different measurement ranges. In this case, the third line L3 may further include a distribution unit (not shown) that distributes the diluted gas to the plurality of particle measurement devices. The distribution unit may distribute the diluted gas at a flow rate suitable for a measurement range of each of the particle measurement devices.

The particle measurement device 140 may further include a data processing unit (not shown) that stores and analyzes measured data. The data processing unit may analyze particle size distribution, concentration distribution, and changes over time. The data processing unit may display the analyzed data via a display apparatus (not shown).

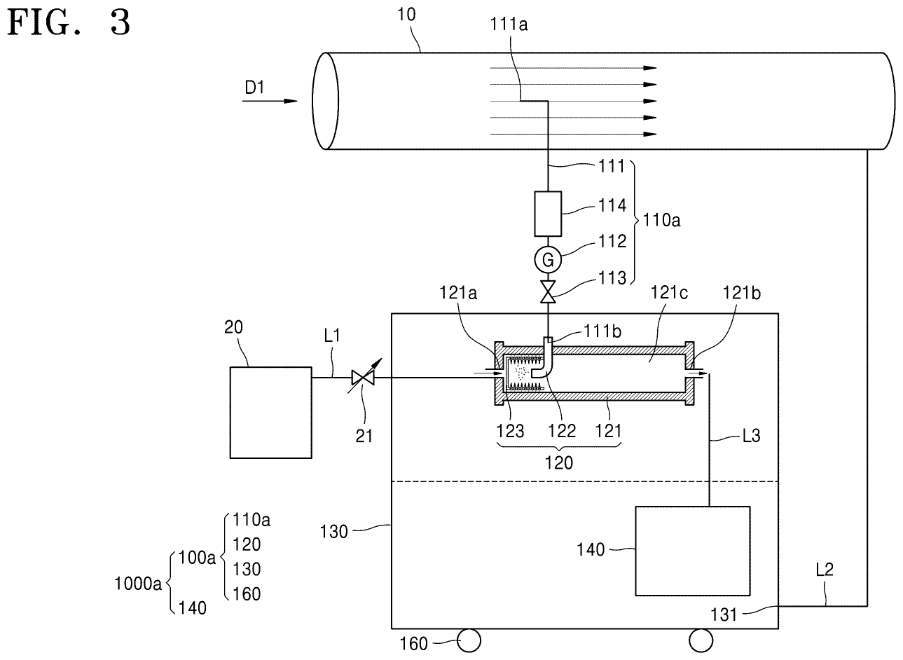

FIG. 3 is a configuration diagram schematically illustrating a particle measurement apparatus including an exhaust gas dilution apparatus, according to another embodiment.

Referring to FIG. 3, an exhaust gas dilution apparatus 100a according to another embodiment may include a sampler 110a, the diluter 120, the housing unit 130, and the mobility unit 160.

The sampler 110a may include the sampling pipe 111, the flow meter 112, the on/off valve 113, and a moisture reducer 114.

The moisture reducer 114 may perform a function of removing moisture from the exhaust gas moving via the sampling pipe 111. The moisture reducer 114 may include, for example, a heating tape or a heating jacket, surrounding an outer side of the sampling pipe 111. The heating tape or the heating jacket may heat the sampling pipe 111 to maintain the temperature of the exhaust gas constant. Accordingly, moisture condensation caused by a decrease in the temperature of the exhaust gas may be prevented.

As another example, the moisture reducer 114 may include a diffusion dryer arranged on a path of the sampling pipe 111. The diffusion dryer may selectively remove moisture from the exhaust gas as the exhaust gas passes therethrough. The diffusion dryer may effectively remove only moisture from the exhaust gas, without affecting particles in the exhaust gas.

The moisture reducer 114 may be installed on the entire sampling pipe 111 or a partial section of the sampling pipe 111. The moisture reducer 114 may be installed on a section of the sampling pipe 111 excluding a section that penetrates the pipe 10. The heating tape or the heating jacket may be installed to surround an outer circumferential surface of the sampling pipe 111 and may have a detachable structure. The diffusion dryer may be connected in series along the path of the sampling pipe 111 and may have a structure that allows easy replacement for maintenance.

The exhausts gas inside the pipe 10 may have a high temperature, and when the high-temperature exhaust gas is sampled to a location external to the pipe 10 which may be at a lower temperature, such as room temperature, moisture in the exhaust gas may condense due to the temperature difference. When moisture condenses, particles may agglomerate with the moisture, leading to clogging of the sampling pipe 111, or particles in the form of water droplets may be sampled, thereby reducing particle measurement accuracy. The moisture reducer 114 may reduce these problems.

The moisture reducer 114 may include an alarm device (not shown) capable of detecting failures or malfunctions. The alarm device may detect temperature abnormalities, power supply interruptions, or a decrease in moisture removal efficiency and alert a user. Accordingly, measurement errors caused by performance degradation of the moisture reducer 114 may be prevented.

The moisture reducer 114 may be electrically connected to a controller (not shown) which may control operation of the moisture reducer 114. The controller may control a heating temperature and heating time of the moisture reducer 114 by monitoring the temperature inside the sampling pipe 111. In the case of the heating tape or the heating jacket, the controller may control power supply to the heating tape or heating jacket based on temperature information received from a temperature sensor (not shown), to maintain the temperature of the sampling pipe 111 constant. In the case of a diffusion dryer, the controller may monitor the humidity inside the dryer to verify drying performance.

Other components of the sampler 110a and other components of the exhaust gas dilution apparatus 100a may have the same or substantially the same configuration and function as like components described with reference to the embodiment of FIG. 1.

A particle measurement apparatus 1000a according to another embodiment may include the exhaust gas dilution apparatus 100a and the particle measurement device 140.

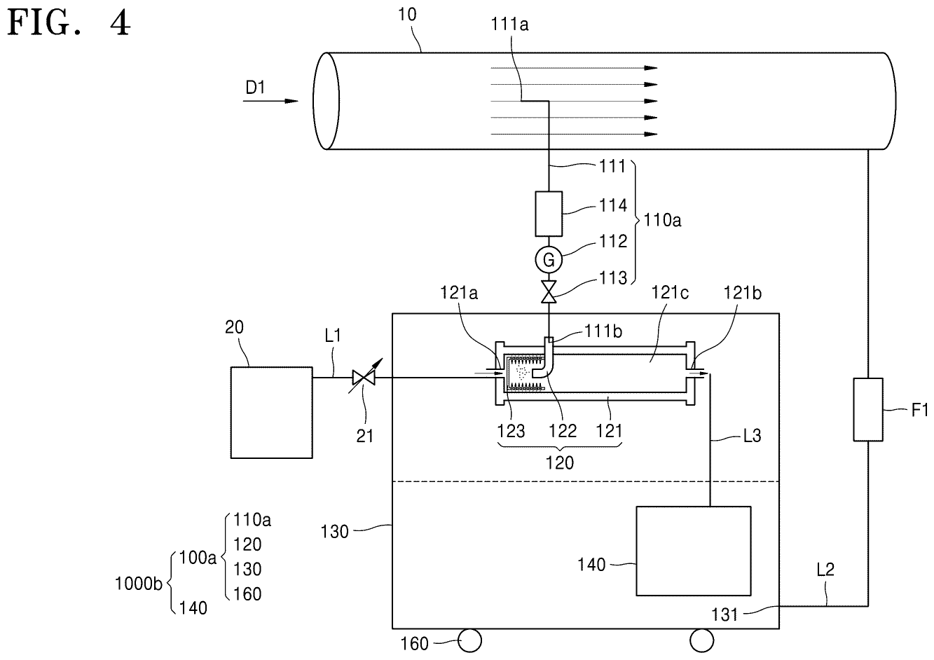

FIG. 4 is a configuration diagram schematically illustrating a particle measurement apparatus including an exhaust gas dilution apparatus, according to another embodiment.

Referring to FIG. 4, a particle measurement apparatus 1000b according to another embodiment differs from that of the embodiment of FIG. 3 in that the particle measurement apparatus 1000b further includes a first filter F1 on the second line L2.

The first filter F1 may be arranged on a path of the second line L2. The first filter F1 may filter particles included in the exhaust gas, diluted gas, or external gas discharged from the first exhaust port 131 of the housing unit 130.

The first filter F1 may be directly connected to the first exhaust port 131 or may be installed in the middle of the second line L2. The first filter F1 may be detachably coupled to the second line L2, and a sealing structure (not shown) for preventing gas leakage may be provided at a coupling interface between the first filter F1 and the second line L2. The first filter F1 may be installed vertically or horizontally and may be installed in a direction to optimize filter performance.

The first filter F1 may be selected according to the characteristics and contaminants of the gas discharged from the housing unit 130. The first filter F1 may include, for example, an acid filter, a base filter, a volatile organic compound (VOC) filter, or a composite filter that combines the functions of the aforementioned filters.

The first filter F1 may remove the particles included in the exhaust gas, the diluted gas, or the external gas before these gases are recirculated to the pipe 10.

The first filter F1 may selected to be a filter with an appropriate specification according to the size of the particles included in the gas discharged from the housing unit 130. The first filter F1 may include, for example, a high-efficiency particulate air (HEPA) filter or an ultra-low penetration air (ULPA) filter.

The first filter F1 may have a multi-stage filter structure in which a plurality of filters are arranged in series according to the size of the particles in the gas. The multi-stage filter structure may sequentially remove particles in an order from larger to smaller sizes, thereby extending filter lifespan.

In the multi-stage filter structure, a filter in each stage may be configured to be independently replaceable. A port (not shown) for pressure monitoring may be provided between filters in each stage, allowing conditions of the filters in each stage to be individually checked. In addition, the filter in each stage may include a check valve (not shown) to prevent backflow.

The first filter F1 may further include a differential pressure sensor (not shown) configured to detect the degree of filter clogging. The differential pressure sensor may measure a pressure difference between a front end and rear end of the first filter F1 and indicate the timing for filter replacement.

The first filter F1 may include a safety device (not shown) to respond to an abnormal situation such as filter damage or performance degradation. The safety device may block the second line L2 when filter damage is detected, thereby preventing contaminated gas from flowing into the pipe 10. In addition, a controller (not shown) may automatically stop the operation of the entire system when an abnormal filter condition is detected.

The differential pressure sensor may be electrically connected to the controller and monitor conditions of the first filter F1 in real-time. The controller may generate an alarm when the differential pressure is greater than a set threshold, and notify a user that filter replacement is required. The first filter F1 may have a structure detachable from the second line L2 for maintenance and may further include a valve (not shown) to prevent gas leakage during replacement.

Other components of an embodiment, that is, the sampler 110a, the diluter 120, the housing unit 130, the particle measurement device 140, and the mobility unit 160 may have the same or substantially the same configuration and function as like components described with reference to the embodiment of FIG. 3.

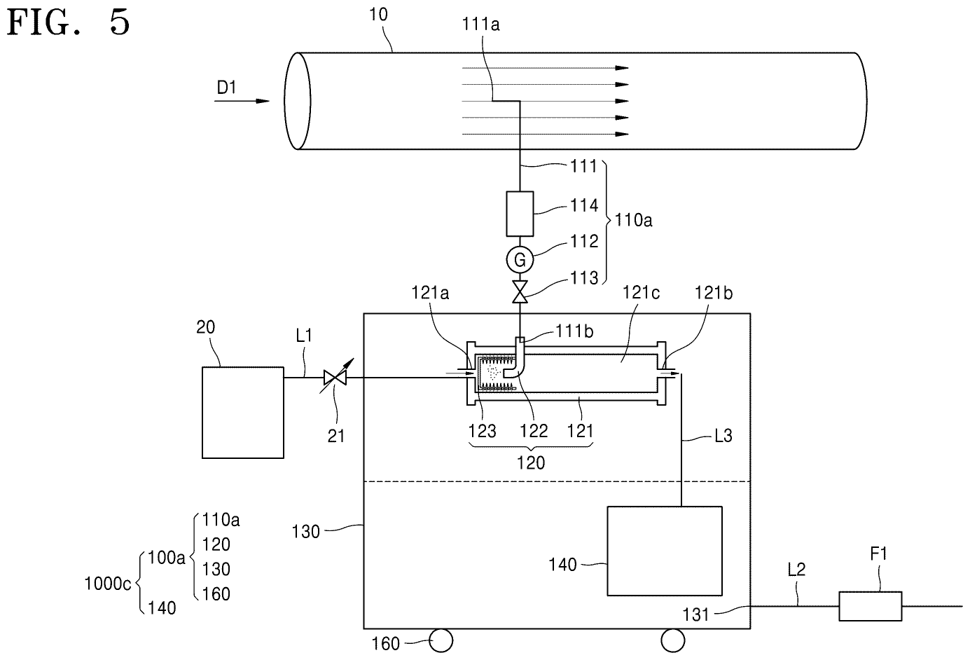

FIG. 5 is a configuration diagram schematically illustrating a particle measurement apparatus including an exhaust gas dilution apparatus, according to another embodiment.

Referring to FIG. 5, a particle measurement apparatus 1000c according to another embodiment differs from that of the embodiment of FIG. 4 in that the second line L2 is not connected to the pipe 10.

The second line L2 may transfer the exhaust gas, diluted gas, or external gas discharged from the first exhaust port 131 of the housing unit 130 to a separate processing device (not shown), without recirculating the exhaust gas, the diluted gas, or the external gas to the pipe 10. The processing device may process the gas transferred via the second line L2.

The second line L2 may include the first filter F1. The second line L2 may have a sealing structure (not shown) for preventing gas leakage at a connection portion with the processing device. A valve (not shown) for flow rate control may be provided between the second line L2 and the processing device, and a gas flow rate may be controlled according to the capacity of the processing device. In addition, a shut-off valve (not shown) may be included to block gas flow during maintenance of the processing device.

The first filter F1 may filter particles included in the gas discharged from the housing unit 130 and then transfer the same to the processing device. The processing device may render harmless the gas filtered by the first filter F1.

The processing device may include, for example, a scrubber, a catalytic oxidizer, an adsorption device, or a combination thereof. The processing device may remove harmful substances included in the exhaust gas or convert the same into harmless substances.

The processing device may be controlled by a controller (not shown). The scrubber may remove harmful substances in gas phase by using a scrubbing liquid, and may include: a pump (not shown) for circulation of the scrubbing liquid; and a scrubbing liquid reservoir (not shown). The catalytic oxidizer may include: a catalyst layer (not shown) for oxidizing harmful substances; and a heating device (not shown) for temperature control. The adsorption device may include: an adsorption tower (not shown) filled with an adsorbent such as activated carbon; and a regeneration device (not shown) for regeneration of the adsorbent.

The processed gas may be released into the atmosphere or reused in another process.

The processing device may include sensors (not shown) to monitor processing efficiency. The sensors may measure gas concentration, temperature, pressure, etc. before and after processing. The controller may analyze the measured data and evaluate the performance of the processing device and, if necessary, automatically control operating conditions of the processing device. When the processing efficiency decreases to less than or equal to a set value, the controller may generate an alarm to notify that maintenance is required.

This configuration may be applied when it is undesirable to recirculate the exhaust gas to the pipe 10. For example, this configuration may be applied when harmful substances included in the exhaust gas may affect a process, or when recirculation of the exhaust gas may reduce process stability.

The processing device may include a safety device (not shown) for emergency situations. The safety device may automatically block gas inflow and switch to an alternative processing path when a malfunction or performance degradation of the processing device is detected. In addition, a bypass line (not shown) may be included to prevent overload of the processing device, and a separate processing facility (not shown) may be provided in the bypass line.

Other components of an embodiment, that is, the sampler 110a, the diluter 120, the housing unit 130, the particle measurement device 140, and the mobility unit 160 may have the same or substantially the same configuration and function as like components described with reference to the embodiment of FIG. 4.

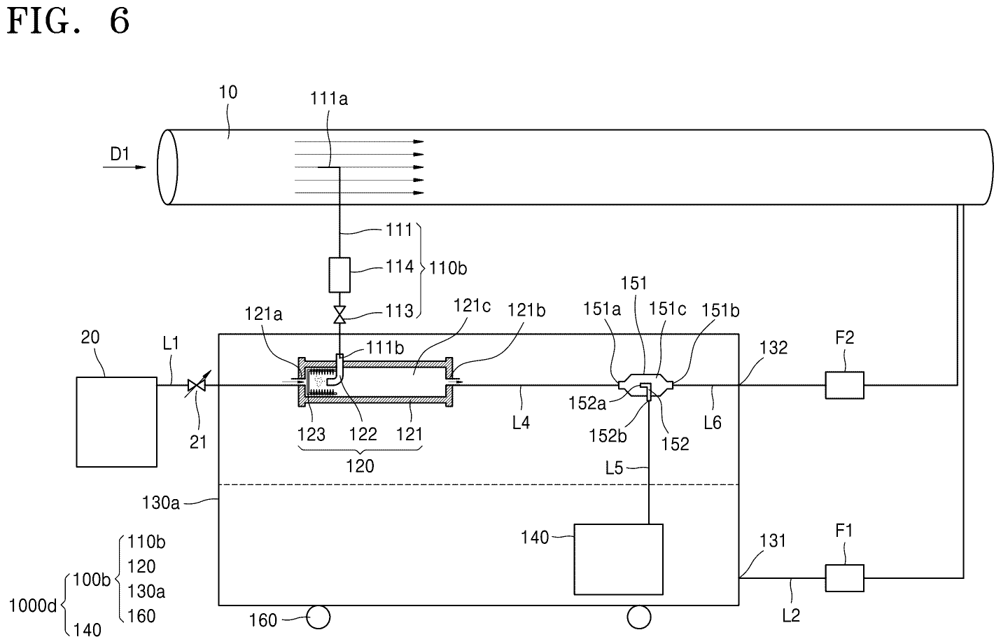

FIG. 6 is a configuration diagram schematically illustrating a particle measurement apparatus including an exhaust gas dilution apparatus, according to another embodiment.

Referring to FIG. 6, an exhaust gas dilution apparatus 100b according to another embodiment has a structural characteristic including a distribution unit 151 and a distribution inlet 152.

The distribution unit 151 may include, as key components for distribution and control of the diluted gas, a first distribution opening 151a, a second distribution opening 151b, and a distribution unit internal space 151c. The distribution unit 151 may perform a function of distributing the diluted gas, which is generated in the diluter 120, to the particle measurement device 140 and the pipe 10. The first distribution opening 151a is connected to the second dilution chamber opening 121b in the diluter 120 via a fourth line L4, and thus, the diluted gas generated in the diluter 120 may flow into the distribution unit 151. The distribution unit internal space 151c may serve as a buffer to temporarily store and uniformly distribute the introduced diluted gas.

The distribution unit 151 may be controlled by a controller (not shown). The controller may monitor the pressure and temperature of the distribution unit internal space 151c to optimize distribution conditions of the diluted gas. A pressure sensor (not shown) and a temperature sensor (not shown) may be provided in the distribution unit internal space 151c, to measure distribution conditions in real-time. Based on the measured data, the controller may automatically control a distribution flow rate.

The distribution inlet 152 has a structure for precise gas distribution and may include a first distribution inlet opening 152a and a second distribution inlet opening 152b. The distribution inlet 152 may perform a function of transferring the diluted gas distributed from the distribution unit 151 to each path. The second distribution inlet opening 152b may be connected to the particle measurement device 140 via a fifth line L5, to transfer a precise amount of diluted gas required for measurement. This distribution system may provide a flow rate optimized for a measurement range of the particle measurement device 140.

The first distribution inlet opening 152a and the second distribution inlet opening 152b, in the distribution inlet 152, may have a precisely machined structure for uniform distribution of the diluted gas. Each of the distribution inlet openings may be provided with a valve (not shown) for flow rate control, and these valves may be independently controlled by the controller. A rectifying structure (not shown) for preventing eddy current may be formed in the distribution inlet 152.

An embodiment may include a sixth line L6 extending to the outside via a second exhaust port 132 of the housing unit 130. The sixth line L6 may be connected to the second distribution inlet opening 152b to recirculate excess diluted gas, which is not used for measurement, to the pipe 10. A second filter F2 may be arranged on the sixth line L6 and effectively filter particles included in the recirculated diluted gas. This recirculation system may increase gas usage efficiency and minimize environmental impact.

The second filter F2 may be equipped with a differential pressure sensor (not shown) to monitor filter conditions. The differential pressure sensor may be electrically connected to the controller and detect the degree of filter clogging in real-time. The second filter F2 may be configured as a cartridge type for easy filter replacement and may include a shut-off device (not shown) to prevent gas leakage during replacement.

A sampler 110b may be optimized to include the sampling pipe 111, the moisture reducer 114, and the on/off valve 113 via structural simplification. This configuration, in which the flow meter 112 is omitted, may be effectively applied when sufficient measurement accuracy may be ensured solely through precise flow rate control via the on/off valve 113. This may reduce system complexity and improve maintenance efficiency.

The exhaust gas dilution apparatus 100b according to an embodiment may include multiple safety devices (not shown) for safe operation of an overall system. The multiple safety devices may include a gas leakage detection sensor, an over-pressure relief valve, and an emergency shut-off device. When gas leakage is detected or the pressure inside the system is greater than a set value, the controller may automatically switch the system into safety mode. In addition, a fail-safe mechanism may be implemented to maintain a safe state even in the event of a power outage or control system failure.

A particle measurement apparatus 1000d according to an embodiment may include the exhaust gas dilution apparatus 100b and the particle measurement device 140. This integrated system enables efficient distribution and recycling of the diluted gas and may significantly improve measurement stability and cost-effectiveness. In particular, precise flow rate control via a distribution system enhances measurement accuracy and improves the overall performance of the system.

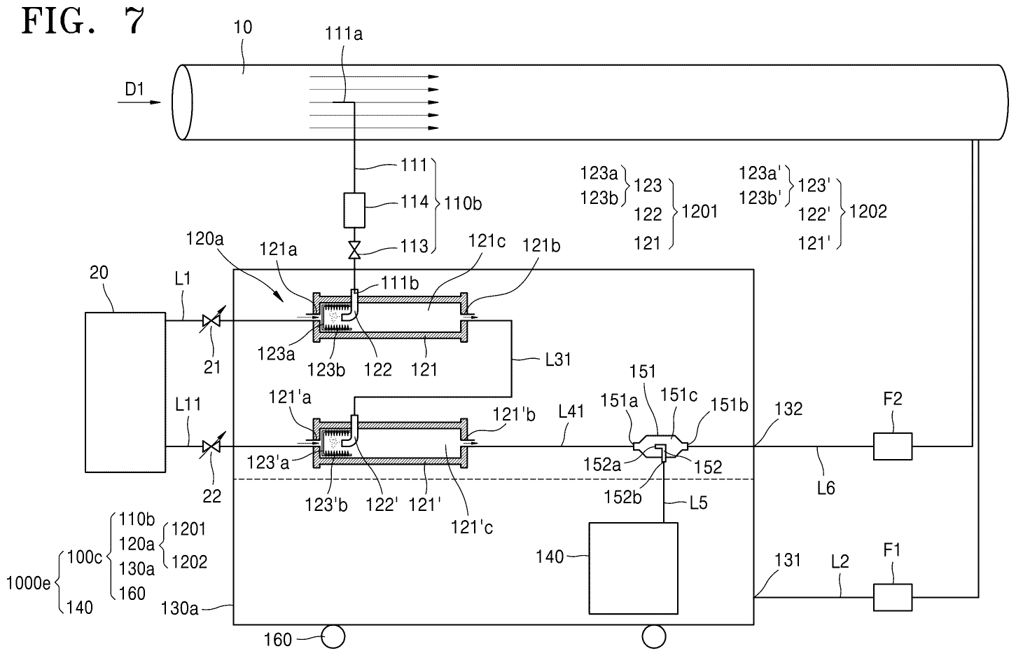

FIG. 7 is a configuration diagram schematically illustrating a particle measurement apparatus including an exhaust gas dilution apparatus, according to another embodiment.

Referring to FIG. 7, an exhaust gas dilution apparatus 100c according to another embodiment has differentiated technical characteristics, including an advanced diluter 120a that implements multi-stage dilution.

The diluter 120a includes two or more independent dilution systems that are connected in series. For example, a first dilution system may include a first dilution chamber 121, a first aerosol inlet 122, and a first path change unit 123, and a second dilution system may include a second dilution chamber 121′, a second aerosol inlet 122′, and a second path change unit 123′. This serial connection structure enables precise dilution of high-concentration particles via a sequential dilution process. As another example, the diluter 120a may include three or more dilution chambers.

The diluter 120a may be integrally controlled by a controller (not shown). The controller may independently control dilution ratios of the first dilution system and the second dilution system. Each of the dilution systems may be equipped with a temperature sensor (not shown) and a pressure sensor (not shown) to monitor dilution conditions in real-time, thereby maintaining optimal dilution conditions.

In the first dilution system, the first dilution chamber 121 may receive the external gas via the first dilution chamber opening 121a, and the external gas may be mixed with the exhaust gas injected via the second inlet opening 122b in the first aerosol inlet 122. The first path change unit 123 may optimize the flow of the external gas via a first partition wall portion 123a and a first porous portion 123b, thereby improving efficiency of primary dilution. Primary diluted gas may be discharged via the second dilution chamber opening 121b.

The primary diluted gas may be transferred to the second aerosol inlet 122′ via a 31^{st} line L31 to undergo a secondary dilution process.

The 31^{st} line L31 may have a rectifying structure (not shown) to stably transfer the primary diluted gas. The 31^{st} line L31 may be equipped with a flow meter (not shown) for flow measurement, allowing real-time monitoring of a flow rate of the primary diluted gas. In addition, the 31^{st} line L31 may be equipped with a sealing structure (not shown) to prevent gas leakage and a shut-off valve (not shown) for maintenance.

The second dilution chamber 121′ may receive, through a third dilution chamber opening 121′a, additional external gas from the external gas supply source 20, which is connected via an 11^{th} line L11. A control valve 22 arranged on the 11^{th} line L11 may precisely control a flow rate of the external gas used for secondary dilution.

The control valves 21 and 22 may be electrically connected to the controller and independently control the flow rate of the external gas. The controller may calculate a dilution ratio at each dilution stage and automatically control the opening of the control valves 21 and 22. Supply conditions of the external gas may be monitored in real-time via a pressure sensor (not shown) and a temperature sensor (not shown), and when an abnormality is detected, the controller may generate an alarm.

A second partition wall portion 123′a and a second porous portion 123′b of the second path change unit 123′ may optimize gas flow in the secondary dilution process.

Finally, secondary diluted gas may be transferred from a fourth dilution chamber 121′b to the distribution unit 151 via a 41^{st} line L41. This multi-stage dilution system allows for independent control of a dilution ratio at each stage, thereby improving precision of the entire dilution process. In addition, stage-by-stage dilution allows for minimizing particle loss and achieving a high dilution ratio.

A particle measurement apparatus 1000e according to an embodiment may be configured by combining the exhaust gas dilution apparatus 100c and the particle measurement device 140. This configuration may be particularly effective in applications requiring precise measurement of high-concentration particles.

The multi-stage dilution system may include independent safety devices (not shown) for each stage. The safety devices may include an over-pressure relief valve, a backflow prevention valve, and a leak detection sensor. The multi-stage dilution system may have a structure that, when an abnormality is detected at any stage, allows bypassing the corresponding stage, enabling dilution solely with the remaining stages. In addition, an emergency stop system (not shown), which may automatically shut off all valves and maintain a safe state in case an emergency stop of the entire system is required, may be implemented.

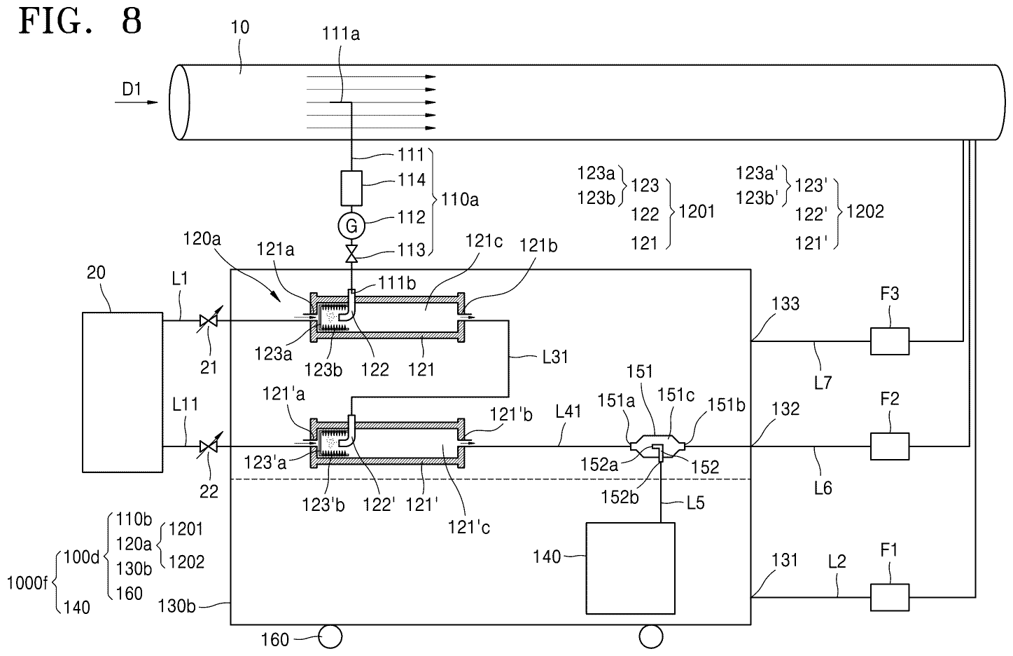

FIG. 8 is a configuration diagram schematically illustrating a particle measurement apparatus including an exhaust gas dilution apparatus, according to another embodiment.

Referring to FIG. 8, an exhaust gas dilution apparatus 100d according to another embodiment may implement efficient processing of the diluted gas via structural characteristics of a housing unit 130b having a plurality of exhaust paths.

The housing unit 130b may provide flexibility in gas processing, via three independent exhaust systems. The first exhaust port 131 is connected to the second line L2 and may recirculate the diluted gas discharged from the particle measurement device 140 to the pipe 10. The first filter F1 may be arranged on the second line L2 and effectively remove particles included in the recirculated diluted gas.

The second exhaust port 132 may be connected to the second distribution opening 151b in the distribution unit 151 via the sixth line L6, and may allow the diluted gas discharged from the second distribution opening 151b to be recirculated to the pipe 10. The second filter F2 may be arranged on the sixth line L6 and effectively remove particles included in the recirculated diluted gas.

A third exhaust port 133 may provide an independent exhaust path via a seventh line L7, and particles included in the exhaust gas may be effectively removed via a third filter F3 installed on the seventh line L7.

This multi-exhaust structure may provide operational flexibility to appropriately handle gases generated under various operating conditions.

The multi-exhaust system of the housing unit 130b may be integrally controlled by a controller (not shown). The controller may monitor the pressure and flow rate in each of the exhaust ports and automatically select an optimal exhaust path. Each exhaust port may be equipped with a pressure sensor (not shown) and a flow rate sensor (not shown), allowing for real-time monitoring of exhaust conditions. The controller may analyze the measured data to automatically switch an exhaust path or control a flow rate.

In addition, the multi-exhaust structure may provide a particle removal function optimized for characteristics and requirements of each of the exhaust paths.

Each exhaust path may be equipped with a switching valve (not shown), allowing for free switching of the exhaust paths. The switching valve may be automatically controlled by the controller, and an interlock system (not shown) may be implemented to prevent gas backflow or leakage during exhaust path switching. In addition, a switching status of each exhaust path may be displayed in real-time via a display apparatus (not shown).

The first filter F1, the second filter F2, and the third filter F3 may use filters with different specifications based on filtering performance required for each path, thereby maximizing filtering efficiency of the entire system.

Each of the filters may be equipped with an independent monitoring system (not shown). The monitoring system may include a differential pressure sensor, a temperature sensor, and a filter lifespan detection sensor. The controller may individually monitor a status of each filter and predict the timing for replacement, and may automatically switch to an alternative path when filter performance degrades. When filter replacement is required, the corresponding path may be blocked, and continuous operation may be ensured via another path.

The sampler 110a may form an integrated sampling system including the sampling pipe 111, the flow meter 112, the on/off valve 113, and the moisture reducer 114. This configuration allows for precise sampling and pre-processing of the exhaust gas. In particular, by effectively removing moisture from the sampled gas via the moisture reducer 114, measurement reliability may be significantly improved.

The diluter 120a may be configured to implement a multi-stage dilution system identical to that shown in the embodiment of FIG. 7, and may be operatively coupled to the distribution unit 151 to facilitate efficient distribution of the diluted gas. This system allows for precise dilution of high-concentration exhaust gas and stable transfer of the diluted gas to the particle measurement device 140.

A particle measurement apparatus 1000f of the present embodiment may be configured by combining the advanced exhaust gas dilution apparatus 100d and the particle measurement device 140. By combining a multi-exhaust system and a precision filtering system, measurement accuracy and system stability may be simultaneously ensured. In particular, the provision of various exhaust paths enables flexible system operation according to measurement conditions, thereby providing important advantages in applications requiring long-term monitoring.

The exhaust gas dilution apparatus 100d according to an embodiment may include an integrated safety management system (not shown). The integrated safety management system may comprehensively monitor the pressure, temperature, flow rate, filter status, etc., of each exhaust path and may automatically perform appropriate response actions in the event of an abnormal situation. In addition, the integrated safety management system may be configured to store and analyze operational data of the system to enable preventive maintenance, and may provide remote monitoring and control functions.

While the inventive concept has been particularly shown and described with reference to embodiments thereof, it will be understood that various changes in form and details may be made therein without departing from the spirit and scope of the following claims.

What is claimed is:

1. An exhaust gas dilution apparatus comprising:
a sampler configured to have a portion arranged in a pipe through which exhaust gas flows and to provide a path through which a portion of the exhaust gas flows outside of the pipe;
a diluter connected to the sampler and configured to receive the portion of exhaust gas diverted from the pipe and dilute the portion of exhaust gas with external gas to generate diluted gas; and
a housing surrounding the diluter and configured to prevent at least one of the exhaust gas and the diluted gas from leaking outside of the diluter.

2. The exhaust gas dilution apparatus of claim 1, wherein the sampler comprises a sampling pipe having a first sampling opening at a first end thereof and a second sampling opening at a second end thereof and providing a path from the first sampling opening to the second sampling opening for the portion of the exhaust gas,
wherein the first sampling opening is configured to be located in the pipe, and the second sampling opening is connected to the diluter in the housing.

3. The exhaust gas dilution apparatus of claim 2, wherein the sampler further comprises:
a flow meter arranged in the path of the sampling pipe and configured to measure a flow rate of the portion of the exhaust gas flowing through the sampling pipe;
an on/off valve arranged in the path of the sampling pipe and configured to control flow of the exhaust gas by opening/closing an inner part of the sampling pipe; and
a moisture reducer that is arranged on the sampling pipe and is configured to prevent condensate from forming from the portion of the exhaust gas flowing through the sampling pipe.

4. The exhaust gas dilution apparatus of claim 3, wherein the moisture reducer comprises a heating element on an outer side of the sampling pipe configured to heat the sampling pipe, or a diffusion dryer arranged in the path of the sampling pipe.

5. The exhaust gas dilution apparatus of claim 1, wherein the diluter comprises:
a dilution chamber configured to receive the portion of the exhaust gas sampled by the sampler, and in which the portion of the exhaust gas is diluted by the external gas to generate the diluted gas; and
an aerosol inlet having a first end connected to the sampler and a second end arranged in the dilution chamber and providing a path through which the portion of the exhaust gas sampled by the sampler is introduced into the dilution chamber,
wherein the dilution chamber comprises:
a first dilution chamber opening configured to receive the external gas; and
a second dilution chamber opening configured to discharge the diluted gas from the dilution chamber,
wherein the aerosol inlet comprises:
a first inlet opening at the first end connected to the sampler; and
a second inlet opening at the second end located in the dilution chamber.

6. The exhaust gas dilution apparatus of claim 5, wherein the first dilution chamber opening and the second dilution chamber opening are collinear.

7. The exhaust gas dilution apparatus of claim 5, wherein the second inlet opening faces the first dilution chamber opening.

8. The exhaust gas dilution apparatus of claim 5, wherein the diluter further comprises a path change unit that is arranged in the dilution chamber and configured to change a direction of movement of the external gas moving into the dilution chamber via the first dilution chamber opening.

9. The exhaust gas dilution apparatus of claim 8, wherein the path change unit comprises:
a partition wall portion that has an area smaller than an inner cross-sectional area of the dilution chamber and is arranged between the first dilution chamber opening and the second inlet opening; and
a porous portion extending from an edge of the partition wall portion in a direction from the first dilution chamber opening toward the second dilution chamber opening and having a porous pattern,
wherein the porous portion is spaced apart from an inner surface of the dilution chamber, and
the exhaust gas dilution apparatus is configured to cause the external gas to flow through the porous pattern to mix with the portion of the exhaust gas introduced via the second inlet opening.

10. The exhaust gas dilution apparatus of claim 1, wherein the housing comprises an exhaust port configured to discharge at least one of the exhaust gas and the diluted gas from inside the housing to outside of the housing.

11. An exhaust gas dilution apparatus comprising:
a sampler having a first end configured to be arranged in a pipe configured to convey an exhaust gas and to provide a path through which a portion of the exhaust gas flows to a second end of the sampler external to the pipe;
a diluter configured to receive the portion of the exhaust gas from the sampler and dilute the portion of the exhaust gas with an external gas to generate diluted gas; and
a housing unit surrounding the diluter and configured to prevent at least one of the exhaust gas and the diluted gas from leaking from the diluter,
wherein the diluter comprises:
a first dilution chamber configured to receive the portion of the exhaust gas from the sampler and to receive the external gas, and to dilute the exhaust gas with the external gas to generate a first diluted gas; and
a second dilution chamber configured to receive the first diluted gas from the first dilution chamber and to receive the external gas, and in which the first diluted gas is further diluted by the external gas to generate a second diluted gas.

12. The exhaust gas dilution apparatus of claim 11, wherein the first dilution chamber comprises:
a first dilution chamber opening configured to introduce the external gas into the first dilution chamber; and
a second dilution chamber opening configured to discharge the first diluted gas from the first dilution chamber into the second dilution chamber,
wherein the second dilution chamber comprises:
a third dilution chamber opening configured to introduce the external gas into the second dilution chamber; and
a fourth dilution chamber opening configured to discharge the second diluted gas from the second dilution chamber.

13. The exhaust gas dilution apparatus of claim 12, wherein the diluter further comprises:
a first aerosol inlet having a first end connected to the sampler and a second end arranged in the first dilution chamber and configured to introduce the portion of the exhaust gas into the first dilution chamber from the sampler;
a second aerosol inlet having a first end configured to receive the first diluted gas discharged from the first dilution chamber and a second end configured to provide a introduce the first diluted gas into the second dilution chamber; and
a connection line connecting the first dilution chamber opening with the first end of the second aerosol inlet and providing a movement path for the first diluted gas.

14. The exhaust gas dilution apparatus of claim 13, wherein the diluter further comprises:
a first path change unit that is arranged in the first dilution chamber and is configured to change a direction of movement of the external gas moving into the first dilution chamber via the first dilution chamber opening; and
a second path change unit that is arranged in the second dilution chamber and is configured to change a direction of the movement of the external gas moving into the second dilution chamber via the third dilution chamber opening.

15. The exhaust gas dilution apparatus of claim 14, wherein the first path change unit comprises:
a first partition wall portion that has an area smaller than an inner cross-sectional area of the first dilution chamber and is arranged between the first dilution chamber opening and the first aerosol inlet; and
a first porous portion extending from an edge of the first partition wall portion in a direction from the first dilution chamber opening toward the second dilution chamber opening and having a first porous pattern,
wherein the first porous portion is spaced apart from an inner surface of the first dilution chamber, and
the first dilution chamber is configured to cause the external gas to flow through the first porous pattern and mix with the portion of the exhaust gas introduced via the first aerosol inlet, and
the second path change unit comprises:
a second partition wall portion that has an area smaller than an inner cross-sectional area of the second dilution chamber and is arranged between the third dilution chamber opening and the second aerosol inlet; and
a second porous portion extending from an edge of the second partition wall portion in a direction from the second dilution chamber opening toward the fourth dilution chamber opening and having a second porous pattern,
wherein the second porous portion is spaced apart from an inner surface of the second dilution chamber, and
the second dilution chamber is configured to cause the external gas to flow through the second porous pattern and mix with the first diluted gas introduced via the second aerosol inlet.

16. The exhaust gas dilution apparatus of claim 11, wherein the sampler comprises:
a sampling pipe having a first sampling opening at the first end thereof and a second sampling opening at the second end thereof and configured to provide a path through which the exhaust gas moves from the first sampling opening to the second sampling opening;
a flow meter arranged in the path of the sampling pipe and configured to measure a flow rate of the portion of the exhaust gas flowing inside the sampling pipe;
an on/off valve that is arranged in the path of the sampling pipe and that is configured to control the flow of the exhaust gas by opening/closing an inner part of the sampling pipe; and
a moisture reducer that is arranged on the sampling pipe and is configured to prevent condensate from forming from the portion of the exhaust gas flowing inside the sampling pipe,
wherein the first sampling opening is configured to be located in the pipe, and the second sampling opening is connected to the diluter in the housing unit.

17. The exhaust gas dilution apparatus of claim 11, wherein the housing unit comprises a plurality of exhaust ports configured to discharge the portion of the exhaust gas inside the housing unit outside of the housing unit.

18. A particle measurement apparatus comprising:
a sampler having a first end configured to be arranged in a pipe through which exhaust gas moves and configured to provide a path through which a portion of the exhaust gas flows to outside of the pipe;
a diluter configured to receive the portion of the exhaust gas from the sampler and dilute the portion of the exhaust gas with an external gas to generate diluted gas;
a particle measurement device configured to measure particles in the diluted gas; and
a housing unit surrounding the diluter and the particle measurement device and configured to prevent leakage of the exhaust gas from at least one of the diluter and the particle measurement device, wherein the diluter comprises at least one dilution chamber configured to receive the portion of the exhaust gas from the sampler and the external gas, and configured to dilute the exhaust gas by the external gas to generate the diluted gas.

19. The particle measurement apparatus of claim 18, further comprising a distribution unit that is arranged between the diluter and the particle measurement device and that is configured to distribute, to the particle measurement device, an amount of the diluted gas required for measurement by the particle measurement device from among the diluted gas discharged from the diluter, and distributes a remaining amount of the diluted gas to an exhaust port of the housing unit.

20. The particle measurement apparatus of claim 19, wherein the sampler comprises:
a sampling pipe having a first sampling opening at a first end thereof and a second sampling opening at a second end thereof and that is configured to provide a path through which the exhaust gas moves from the first sampling opening to the second sampling opening;
a flow meter arranged in the path of the sampling pipe and that is configured to measure a flow rate of the exhaust gas flowing through the sampling pipe;
an on/off valve that is arranged in the path of the sampling pipe and that is configured to control the flow of the exhaust gas by opening/closing an inner part of the sampling pipe; and
a moisture reducer that is arranged on the sampling pipe and is configured to prevent condensate from forming from the exhaust gas inside the sampling pipe,
wherein the first sampling opening is configured to be located in the pipe, and the second sampling opening is connected to the diluter in the housing unit.
